(19) United States
(12) Patent Application Publication
(10) Pub. No.: US 2013/0103489 A1
(43) Pub. Date: Apr. 25, 2013

(54) METHODS, SYSTEMS AND APPARATUS TO MONITOR A MARKETING CAMPAIGN

(71) Applicants: Christina Levins Nicholson, Spring Branch, TX (US); Marc Lagrois, Calabasas, CA (US)

(72) Inventors: Christina Levins Nicholson, Spring Branch, TX (US); Marc Lagrois, Calabasas, CA (US)

(21) Appl. No.: 13/280,686

(22) Filed: Oct. 25, 2011

Related U.S. Application Data
(60) Provisional application No. 61/549,673, filed on Oct. 20, 2011.

(51) Int. Cl. G06Q 30/02

(52) U.S. Cl. 705/14.41

(57) ABSTRACT

Example methods, apparatus, systems, and computer-readable storage media to monitor a marketing campaign are disclosed. An example method includes calculating a breakthrough metric based on a weighted average of an aided awareness score and an unaided awareness score, the breakthrough metric indicating a level of awareness of a film among consumers. The example method includes calculating a persuasion metric based on a weighted average of a first choice score and a definite interest score, the persuasion metric indicating a level of interest in the film among consumers. The example method includes generating a report reflecting an effectiveness of the marketing campaign based on the breakthrough metric and the persuasion metric.

### RELATED APPLICATION

This patent claims priority to U.S. Provisional Application Ser. No. 61/549,673, entitled “Methods, Systems and Apparatus to Monitor a Marketing Campaign,” which was filed on Oct. 20, 2011 and is hereby incorporated herein by reference in its entirety.

### FIELD OF THE DISCLOSURE

The present disclosure relates generally to media measurement and, more particularly, to methods, systems and apparatus to monitor a marketing campaign.

### BACKGROUND

Consumer surveys and/or media tracking is sometimes used to collect data and/or information related to media, such as consumer exposure to television, radio, film (e.g., box offices movies), and/or music. Consumer demographic information is also typically collected in connection with such surveys. Data and/or information related to media exposure and/or demographic information is valuable to advertisers, broadcasters, distributors and/or other entities. For example, audience size and demographic information is a factor in the placement of advertisements, as well as a factor in valuing commercial time slots during a particular program.

### BRIEF DESCRIPTION OF THE DRAWINGS

FIG. 1 illustrates an example system implemented in accordance with the teachings of this disclosure to monitor a marketing campaign.

FIG. 2 illustrates an example implementation of the campaign monitor of FIG. 1.

FIG. 3 is a flow diagram representative of example machine readable instructions that may be executed to implement the example breakthrough calculator of FIG. 2.

FIG. 4 is a flow diagram representative of example machine readable instructions that may be executed to implement the example persuasion calculator of FIG. 2.

FIG. 5 is a flow diagram representative of example machine readable instructions that may be executed to implement the example report creator of FIG. 2.

FIGS. 6-10 illustrate example reports created by the campaign monitor of FIG. 1.

FIG. 11 is a block diagram of an example processor platform that may be used to execute the instructions of FIGS. 3-5 to implement the example breakthrough calculator of FIG. 2, the example persuasion calculator of FIG. 2, the example report creator of FIG. 2, the example campaign monitor of FIG. 2, and/or, more generally, the example system of FIG. 1.

### DETAILED DESCRIPTION

Audience measurement companies monitor consumer exposure to media (e.g., television, radio, Internet, advertising, signage, outdoor advertising, in theater movies, etc.). In some instances, audience measurement companies survey consumers to obtain information regarding exposure to media and/or to collect demographic information of the consumers. Exposure and/or demographic information is valuable to companies in, for example, determining a marketing strategy and/or evaluating the effectiveness of a marketing strategy.

The motion picture industry faces unique marketing challenges. Oftentimes, an advertising campaign for a film to be released in theaters has a short window of time in which to focus the campaign. For example, a campaign may only run for a short time (e.g., three weeks) prior to a film's release. However, movies often run in theaters for short time periods (e.g., weeks or in some cases months). Therefore, a company marketing a film may wish to determine and/or analyze the effectiveness of the marketing campaign in real-time prior to the film's release, rather than analyzing the effectiveness of the campaign after the film's release. Analyzing and/or determining the effectiveness of the marketing campaign prior to the film's release allows the company to adjust the marketing campaign to increase the effectiveness of the marketing campaign and the likelihood of box office success. Given the relatively short run times of movies, later determinations of effectiveness may be of little value as it may come too late to make adjustments.

Example methods, apparatus, systems, and/or computer-readable storage media disclosed herein monitor a marketing campaign prior to a film's release and analyze and/or illustrate an effectiveness of the marketing campaign to enable changes in the campaign prior to the film's release in order to increase the film's box office success. For instance, a disclosed example method includes calculating a breakthrough metric based on a weighted average of an aided awareness score and an unaided awareness score. The breakthrough metric indicates a level of awareness of a film among consumers. The disclosed example method includes calculating a persuasion metric based on a weighted average of a first choice score and a definite interest score. The persuasion metric indicates a level of interest in the film among consumers. The disclosed example method includes generating a report to reflect an effectiveness of the marketing campaign based on the breakthrough metric and the persuasion metric.

A disclosed example system includes a breakthrough calculator to calculate a breakthrough metric based on an aided awareness score and an unaided awareness score. The breakthrough metric indicates a level of awareness of a film among consumers and is, thus, a reflection of an effectiveness of the marketing campaign. The disclosed example system includes a persuasion calculator to calculate a persuasion metric based on a first choice score and a definite interest score. The persuasion metric indicates a level of interest in the film among consumers, and is, thus, a reflection of an effectiveness of the marketing campaign.

A disclosed example computer-readable storage medium comprises instructions that, when executed, cause a computing device to at least calculate a breakthrough metric based on a weighted average of an aided awareness score and an unaided awareness score. The breakthrough metric indicates a level of awareness of a film among consumers. The disclosed example computer-readable storage medium comprises instructions that, when executed, cause a computing device to at least calculate a persuasion metric based on a weighted average of a first choice score and a definite interest score. The persuasion metric indicates a level of interest in the film among consumers. The disclosed example computer-readable storage medium comprises instructions that, when executed, cause a computing device to at least generate a report reflecting an effectiveness of the marketing campaign based on the breakthrough metric and the persuasion metric.

In some examples disclosed herein, a campaign monitor calculates a breakthrough metric and a persuasion metric for an upcoming film (e.g., a movie to be released in theaters). The breakthrough metric and the persuasion metric are used in creating reports to analyze and/or illustrate an effectiveness of a marketing campaign for the film prior to the film's release and/or a short time after the film's release. In the illustrated examples, a breakthrough metric illustrates how much the marketing campaign has been able to grow consumer (e.g., moviegoer) awareness of the film. In the illustrated examples, a persuasion metric illustrates how much the marketing campaign has been able to grow consumer (e.g., moviegoer) interest in the film.

The breakthrough and persuasion metrics are used, for example, to create a breakthrough to persuasion conversion report. The breakthrough to persuasion conversion report of the illustrated examples compares levels of persuasion to levels of breakthrough to illustrate how well the marketing campaign converts awareness (e.g. as measured by the breakthrough metric) to interest (e.g., as measured by the persuasion metric). This conversion metric is a measure of how interested consumers are in seeing a film they are aware of. For example, a report may illustrate that a film has a relatively strong persuasion level given a level of awareness of the film (e.g., 70% of surveyed consumers are aware of the film and 63% of surveyed consumers are interested in seeing the film). Alternatively or additionally, the report may show that although awareness of the film is not high among consumers, consumers that are aware of the film do want to see it. Thus, in such an example, an increase in awareness-driving marketing could increase the film's box office success because those consumers that are aware of the film do wish to see it and, thus, increasing awareness of the existence of the film should drive more viewers.

The breakthrough and persuasion metrics are also used, for example, to create growth and momentum reports. A breakthrough growth report of the illustrated examples illustrates growth of the breakthrough metric during the time prior to a film's release (e.g., the growth of the breakthrough metric from three weeks prior to a film's release to the film's release). A persuasion growth report of the illustrated examples illustrates growth of the persuasion metric during the time prior to a film's release (e.g., the growth of the persuasion metric from three weeks prior to a film's release to the film's release). The breakthrough growth and the persuasion growth are used, for example, to create a momentum report. The momentum report of the illustrated examples illustrates a marketing campaign's overall success at growing key tracking metrics (e.g., breakthrough and persuasion metrics). In the illustrated examples, the momentum report is created by averaging the breakthrough growth and the persuasion growth.

Example reports disclosed herein may illustrate areas in which to increase marketing (for example, online forums), aspects of the film to focus marketing upon (for example, a certain starring actor), demographic groups to focus marketing upon (for example, females under the age of 25), etc. Analyzing the marketing campaign prior to the film's release enables the marketing campaign to be adjusted at a time at which box office success may still be effected (e.g., prior to the film's release), and, thus, offer an opportunity to increase the film's box office success.

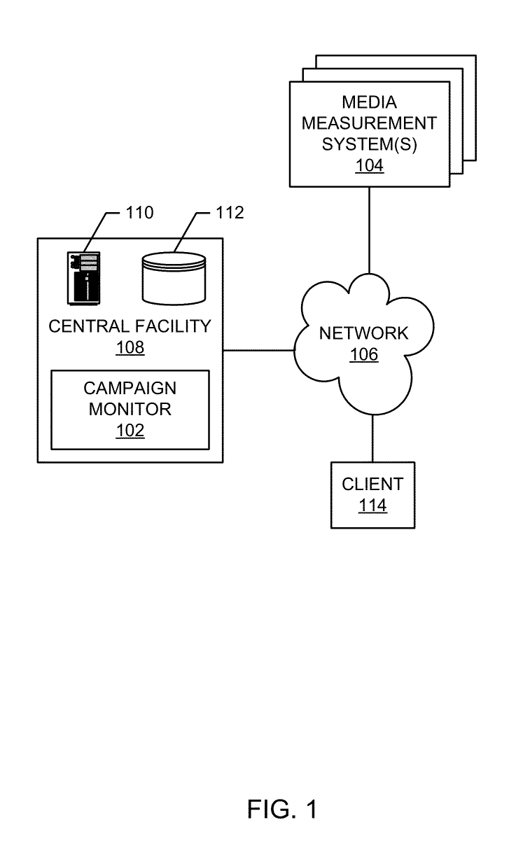

FIG. 1 illustrates an example campaign monitor 102 constructed in accordance with the teachings of this disclosure to monitor a marketing campaign associated with an upcoming release of a film. Media measurement system(s) 104 collect awareness and/or interest information about an upcoming film. This information may be segmented or otherwise tied to demographic information. For example, the media measurement system(s) 104 of the illustrated example survey consumers regarding their awareness and/or interest in upcoming films and/or track online conversations regarding the upcoming films. The collected information is provided to the campaign monitor 102. The campaign monitor 102 of the illustrated example calculates a breakthrough metric and a persuasion metric, and creates reports based on one or more of these metrics to illustrate the present effectiveness of the marketing campaign(s) associated with the film. The campaign monitor 102 of the illustrated example provides the reports to a client 114 to allow the client 114 to analyze and/or act upon the information (e.g., to adjust marketing techniques and/or improve the effectiveness of the marketing campaign prior to, and/or shortly after, the release of the film when such changes may still have a positive effect on ticket sales).

In the example of FIG. 1, the media measurement system(s) 104 track and/or survey consumers regarding their awareness and/or interest in upcoming films to be released. The example media measurement system(s) 104 of FIG. 1 may be implemented, for example, by an audience measurement company. The media measurement system(s) 104 may track and/or survey consumers continuously, periodically, and/or aperiodically (e.g., daily, once a week, etc.). Additionally, the media measurement system(s) 104 of the illustrated example may record demographic information for each consumer participating in a survey and/or being tracked. For example, the example media measurement system(s) 104 of FIG. 1 record gender and/or age of participating consumers. The media measurement system(s) 104 may also categorize the films used in the surveys and/or tracking. For example, the media measurement system(s) 104 of the illustrated example categorize the films based on genre, such as, for example, action, comedy, drama, family, etc.

In the example of FIG. 1, the media measurement system(s) 104 survey consumers to determine their levels of awareness of upcoming films which are soon to be released (e.g., within the next few weeks, the next few months, etc). To determine consumer levels of awareness of a film, the media measurement system(s) 104 determine a level of unaided awareness of the film and a level of aided awareness of the film. Unaided awareness is defined herein to be a percentage of consumers who volunteer that they are aware of a title of the film without direct prompting with an identifier of the film. For example, 20% of surveyed consumers may volunteer that they are aware of the film without being told the name of the film. Aided awareness is defined herein to be a percentage of consumers claiming they are aware of the film when prompted with an identifier of the film (e.g., with a list of film titles including the title of interest). For example, 70% of surveyed consumers may claim they have heard of the film of interest when they see a list with a plurality of film titles. The unaided and aided awareness levels determined by the media measurement system(s) 104 of the illustrated example indicate levels of in-market awareness of consumers regarding the upcoming film of interest.

In the example of FIG. 1, the media measurement system(s) 104 additionally survey consumers to determine their levels of interest in upcoming films to be released. To determine consumer levels of interest in a film, the media measurement system(s) 104 of the illustrated example determine a level of “first choice” to see the film and a level of “definite interest” in the film. The level of first choice is defined herein to be a percentage of consumers volunteering that the film of interest to the survey is their first choice to see in theaters (i.e., they are more interested in seeing the film of interest to the survey than seeing any other film in a set of films). For example, 16% of surveyed consumers may volunteer that the film of interest to the survey is their first choice to see. The level of definite interest is defined herein to be a percentage of consumers declaring they are definitely interested in seeing the film in theaters when directly asked about the film of interest to the survey. For example, 59% of surveyed consumers may declare they would definitely be interested in seeing the film of interest in the survey in theaters. The first choice and definite interest levels determined by the media measurement system(s) 104 of the illustrated example provide measures of in-market interest of consumers in seeing upcoming films.

In the example of FIG. 1, the media measurement system(s) 104 additionally survey consumers to determine their perceptions about the upcoming film. The data collected by these perception surveys is referred to as “diagnostic survey data.” The diagnostic survey data may be used, for example, to evaluate aspects of the film that are driving or limiting interest in the title (e.g., what makes consumers want to see the film and what makes consumers not want to see the film). The media measurement system(s) 104 of the illustrated example collect diagnostic survey data related to, for example, consumers' interest in a film genre, actor, creator, story, cinematography, special effects, director, etc. The media measurement system(s) 104 of the illustrated example also collect diagnostic survey data related to, for example, type(s) of interesting advertising (e.g., TV, online, newspapers, theater previews, etc.), consumer expectations for the film of interest (e.g., fun, good date movie, good story, thrilling, etc.), effectiveness of advertising (e.g., how much consumers like characters, understand conflicts, can connect with the film, etc.), consumer expectations of reactions to the film of interest (e.g., laugh, feel sad, become bored, feel uplifted, etc.), etc.

The media measurement system(s) 104 of the illustrated example additionally track online conversations of consumers related to upcoming film releases. The media measurement system(s) 104 of the illustrated example use queries to capture online conversations that pertain to the film. The online conversations may be located on, for example, blogs, message boards, social networking cites, etc. and may be sorted by their associated location (e.g., the conversations are grouped based on location). A query may search, for example, for the title of the film, a character, an actor, a phrase associated with the film, an advertisement associated with the film, and/or a phrase indicating a level of interest in the film. A phrase indicating an interest level may be, for example, “can't wait to see.” The media measurement system(s) 104 of the illustrated example code some interest level phrases based on their tone. For example, the media measurement system(s) 104 of the illustrated example code the collected phrases as positive, negative, and/or neutral in tone.

The media measurement system(s) 104 of the illustrated example also categorize online conversations as pertaining to a specific category. Categories may be genre-neutral. For example, genre-neutral categories include actors, directors, studios, distributors, character, trailers and/or promotions. Additionally or alternatively, categories may be genre-specific. For example, horror films may have a category for “scary.”

The media measurement system(s) 104 of the illustrated example track advertisements related to an upcoming film release. For example, the media measurement system(s) 104 determine a number of times an advertisement for a film is shown on a television of a panelist participating in the study. A panelist is a person who has agreed to be part of an audience measurement study. A panelist provides their demographic information to the audience measurement entity conducting the study when the panelist(s) agree to participate in the study.

The media measurement system(s) 104 of the illustrated example pass survey data and/or tracking data related to the upcoming release of the film to the campaign monitor 102 via a network 106. The network 106 of the illustrated example may be implemented using any wired and/or wireless communication system including, for example, one or more of the Internet, telephone lines, a cable system, a satellite system, a cellular communication system, AC power lines, etc.

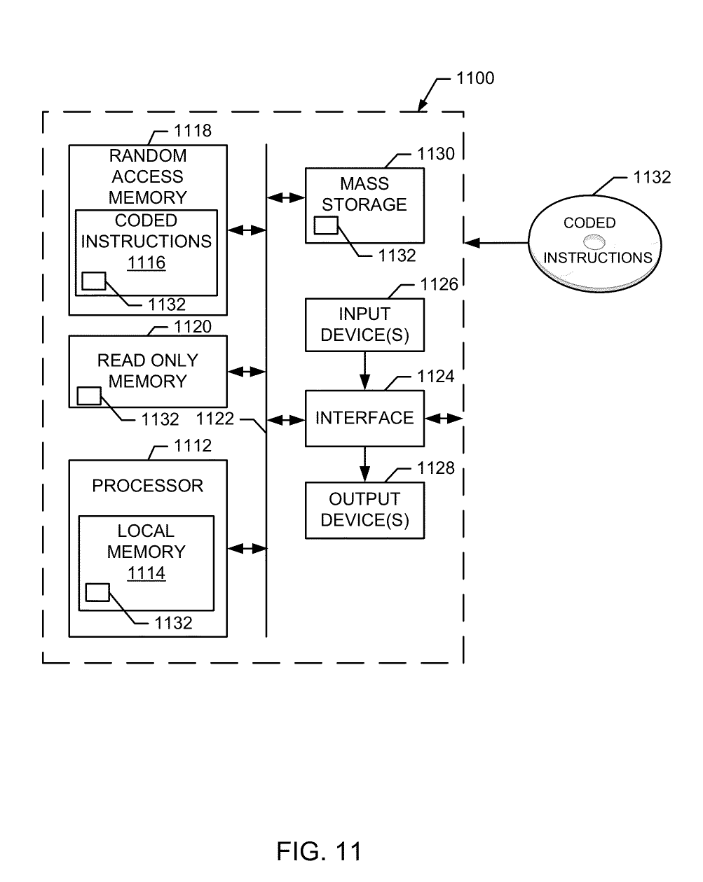

The campaign monitor 102 of the illustrated example is located in a central facility 108 associated with, for example, an audience measurement entity conducting the study. The central facility 108 of the illustrated example collects and/or stores, for example, media data, awareness data, interest data, aided awareness scores, unaided awareness scores, first choice scores, definite interest scores, media monitoring data, demographic information, diagnostic survey data, data representing exposure to media (e.g., content and/or advertisements), and/or marketing campaign information that is collected from panelists at registration and/or by various media measurement system(s) such as, for example, the media measurement system(s) 104. This data is collectively and/or individually referred to herein as “survey data” and/or “tracking data.” The central facility 108 may be, for example, a facility associated with The Nielsen Company (US), LLC or an affiliate of The Nielsen Company (US), LLC. The central facility 108 of the illustrated example includes a server 110 and a database 112 that may be implemented using any number and/or type(s) of suitable processor(s), memor(ies), and/or data storage apparatus such as that shown in FIG. 11.

The campaign monitor 102 of the illustrated example calculates a breakthrough metric and a persuasion metric using the survey data collected by the media measurement system(s) 104 and/or the central facility 108. The breakthrough metric and the persuasion metric employed in the illustrated example correlate with box office success. The reports created by the campaign monitor 102 of the illustrated example may allow the client 114 to adjust marketing campaign(s) to improve box office success. The campaign monitor 102 of the illustrated example provides the reports to the client 114 via the network 106. However, other communication mediums may additionally or alternatively be employed.

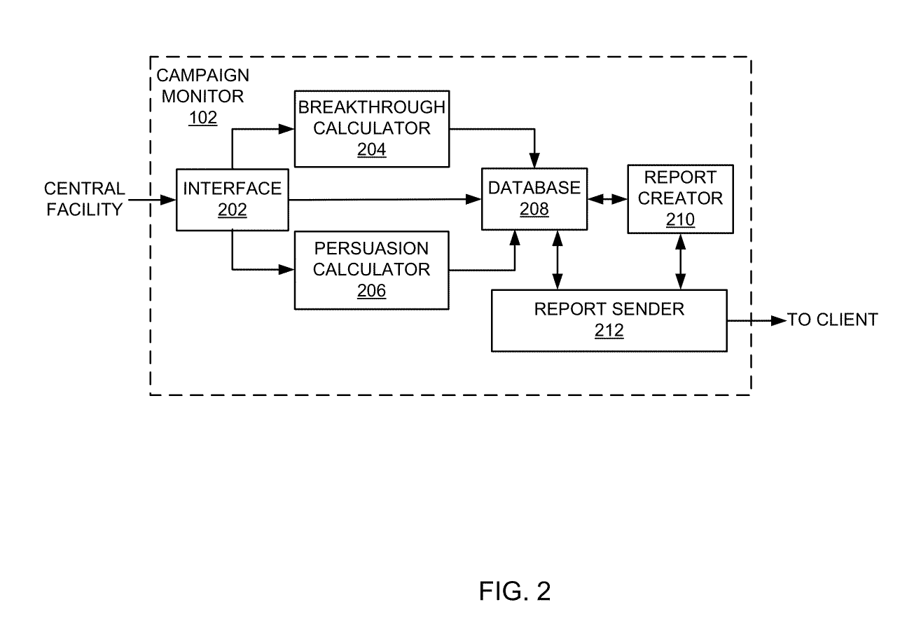

FIG. 2 is a block diagram of an example implementation of the campaign monitor 102 of FIG. 1. As described above, the media measurement system(s) 104 of the illustrated example collect survey and/or tracking data related to a marketing campaign for an upcoming film (e.g., a movie to be released in movie theaters at some future date). The survey and/or tracking data is aggregated and/or stored, for example, in a central facility, such as the central facility 108 of FIG. 1. The campaign monitor 102 of the illustrated example receives the data aggregated at the central facility 108, processes the data, and creates one or more reports to be distributed to one or more clients, such as the client 114 of FIG. 1. The campaign monitor 102 of the illustrated example includes an interface 202, a breakthrough calculator 204, a persuasion calculator 206, a database 208, a report creator 210, and a report sender 212.

In the illustrated example, the interface 202 receives survey and/or tracking data from the central facility 108. For example, the interface 202 receives aided and unaided awareness scores that represent aggregate levels of awareness of consumers in an upcoming film release. In the example of FIG. 2, the aided and unaided awareness scores are represented as percentages of a measured population that are aware of the upcoming film. In the illustrated example, the aided and unaided awareness scores may be based on the measured population as a whole and/or may be based on a subset of the measured population (e.g., a group of respondents that may be categorized based on demographic information, such as, for example, age, gender, geographic location, etc.). For example, a first set of aided and unaided awareness scores may represent levels of awareness of women under 25 and another set of aided and unaided awareness scores may represent levels of awareness of men under 25.

Additionally, the interface 202 of the illustrated example receives first choice and definite interest scores that represent aggregate levels of interest of consumers in an upcoming film release. In the example of FIG. 2, the first choice and definite interest scores are represented as percentages of a measured population. In the illustrated example, the first choice and definite interest scores may be based on the measured population as a whole and/or may be based on a subset of the measured population (e.g., an amount of panelists that may be categorized based on demographics).

The breakthrough calculator 204 of the illustrated example receives the aided and unaided awareness scores from the interface 202. In the example of FIG. 2, the breakthrough calculator 204 calculates a breakthrough metric for the upcoming film using a weighted average of the aided and unaided awareness scores. In the illustrated example, the aided and unaided awareness scores may be based on the measured population as a whole and/or a subset of the measured population. Thus, the breakthrough metric may be calculated based on the measured population as a whole and/or a subset of the measured population. For example, the weighted average for the measured population as a whole may be based on a product of a first weight A (e.g., 25%) and the aided awareness score for the measured population as a whole and a product of a second weight B (e.g., 75%) and the unaided awareness score for the measured population as a whole. Using a weighted average of the aided and unaided awareness scores to calculate the breakthrough metric offers an increased predictability in box office success that may be used to more accurately evaluate the effectiveness of a marketing campaign than was possible previously. For example, the breakthrough calculator 204 may calculate a breakthrough metric of 36.25 by adding the product of 25% and an aided awareness score of 70 with the product of 75% and an unaided awareness score of 25. In the illustrated example, a breakthrough metric is calculated for the measured population as a whole (i.e., all of the surveyed consumers) and, additionally, a breakthrough metric is calculated for each of a plurality of demographic groups of the measured population.

The persuasion calculator 206 of the illustrated example receives the first choice and definite interest scores from the interface 202. In the example of FIG. 2, the persuasion calculator 206 calculates a persuasion metric for an upcoming film using a weighted average of the first choice and definite interest scores. In the illustrated example, the first choice and definite interest scores may be based on the measured population as a whole and/or a subset of the measured population. Thus, the persuasion metric may be calculated based on the measured population as a whole and/or a subset of the measured population. For example, the weighted average for the measured population as a whole may be based on a product of a first weight A (e.g., 75%) and the first choice score and a product of a second weight B (e.g., 25%) and the definite interest score. Using a weighted average of the first choice and definite interest scores to calculate the persuasion metric offers an increased predictability in box office success that may be used to more accurately evaluate the effectiveness of a marketing campaign. For example, the persuasion calculator 206 may calculate a persuasion metric of 32.5 by adding the product of 75% and a first choice score of 15 with the product of 25% and a definite interest score of 85. In the illustrated example, a persuasion metric is calculated for the measured population as a whole (i.e., all of the surveyed consumers) and, additionally, a persuasion metric is calculated for each of a plurality of demographic groups of the measured population.

In the illustrated example, the weighted averages used to calculate the breakthrough and persuasion metrics are selected to improve (e.g., optimize) the correlation of the measures with box office sales and/or revenue. While the weighted averages of the illustrated examples use first and second weighting factors of 75% and 25%, respectively, to calculate the breakthrough and persuasion metrics, in other examples, different weighting factors are used.

The database 208 of the illustrated example receives the breakthrough metric(s) from the breakthrough calculator 204 and the persuasion metric(s) from the persuasion calculator 206 and stores the metrics to be used by the report creator 210. The breakthrough and persuasion metrics are stored in the database 208 with an identifier of the corresponding film and/or an identifier of the corresponding film genre (e.g., action, comedy, drama, etc.) to which they pertain. Additionally, the database 208 of the illustrated example receives other survey and/or tracking data via the interface 202. For example, the database 208 of the illustrated example stores diagnostic survey data gathered from consumer surveys and stores data gathered from the tracking and/or monitoring of online conversations regarding the upcoming film release. The database 208 may store the diagnostic survey data and/or tracking data based on a location of the conversation (e.g., a blog, message board, social networking cite, etc.), a genre or characteristic of the film, and/or a tone of the conversation (e.g., positive, negative, neutral, etc.). Additionally, the database 208 of the illustrated example stores data related to the tracking of advertisements for upcoming film(s). The database 208 of the illustrated example stores historical survey and/or tracking data to be used by the report creator 210 to provide a historical perspective of the effectiveness of the marketing campaign.

The report creator 210 of the illustrated example uses survey and/or tracking data from the database 208 to create report(s) to, for example, assist the client 114 in evaluating the effectiveness of a marketing campaign associated with an upcoming film release. In some examples, report(s) created by the report creator 210 utilize the historical data stored in the database 208 to compare the strength of a marketing campaign of an upcoming film to one or more marketing campaign(s) of one or more previously released film(s).

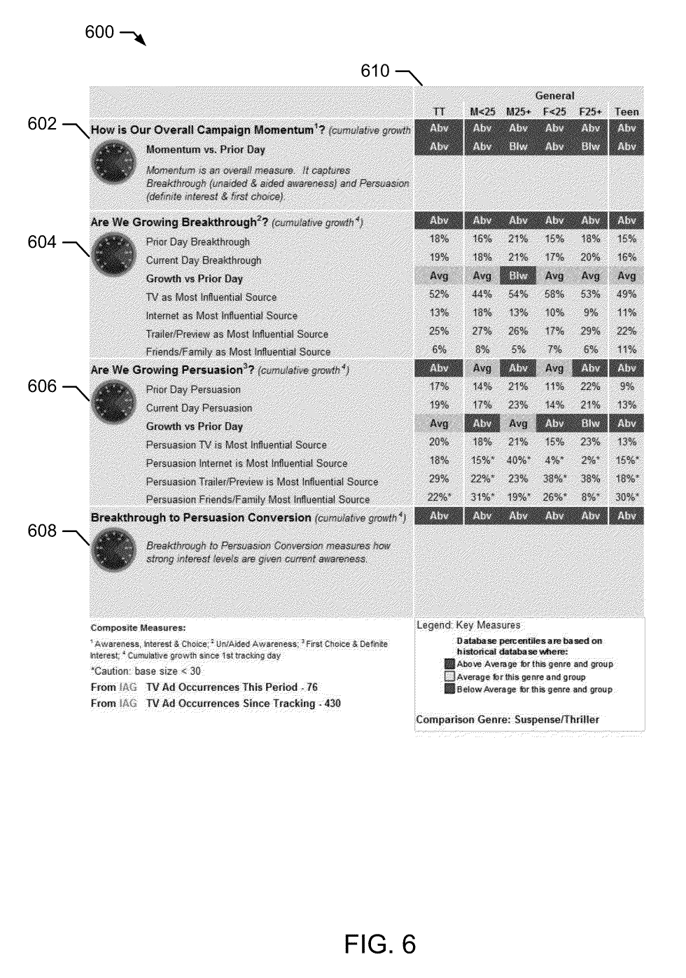

In the example of FIG. 2, the report creator 210 creates a breakthrough to persuasion conversion report utilizing the breakthrough and persuasion metrics calculated by the breakthrough calculator 204 and the persuasion calculator 206, respectively. For example, the report creator 210 may use the breakthrough metric (e.g., 36.25) and the persuasion metric (e.g., 32.5) from the examples illustrated above. An example breakthrough to persuasion conversion metric is included in the example report illustrated in FIG. 6. The breakthrough to persuasion conversion report of the illustrated examples compares levels of persuasion to levels of breakthrough to illustrate how well the marketing campaign converts awareness to interest (e.g., how many consumers are interested in seeing the film compared to how many consumers are aware of the film). The breakthrough to persuasion conversion report created by the report creator 210 of the illustrated example compares levels of persuasion to levels of breakthrough, at particular point(s) in time before the release of the film. For example, the breakthrough to persuasion report may show that an upcoming film has a persuasion score of 32.5 and a breakthrough score of 36.25 two weeks prior to the film's release.

The breakthrough to persuasion report of the illustrated example provides a historical perspective by ranking these scores against the scores of previously released films. For example, the breakthrough and persuasion scores for the film of interest two weeks prior to the film's release are compared to the breakthrough and persuasion scores for previously released films two weeks prior to their respective release dates. To this end, the breakthrough to persuasion report provides a ranking for the film of interest to show how the breakthrough and persuasion scores compare to those of previously released films. The ranking may be determined using a lookup grid or table. For example, if the film of interest is to be analyzed two weeks prior to its opening, a lookup grid will be used for this specific time period. The lookup grid may contain, for example, multiple levels of breakthrough metrics (e.g., a breakthrough of 10, a breakthrough of 15, a breakthrough of 20, etc.). For each level of breakthrough, the lookup grid may contain, for example, multiple levels of persuasion metrics (e.g., a persuasion of 5, a persuasion of 10, a persuasion of 20, etc.) The lookup grid may show, for example, a percentile ranking for each persuasion level at each breakthrough level. For example, if the film of interest has a breakthrough score of 10 and a persuasion score of 5, the report creator 210 may look up a persuasion score of 5 under a breakthrough column of 10 and return a percentile value, such as the 10^{th} percentile. The breakthrough to persuasion report may provide the percentile ranking to illustrate the percentage of previously released films which the current film has scored above (e.g., films with either a lower breakthrough score, a lower persuasion score, or both). Using the rankings, the report of the illustrated example shows whether the breakthrough to persuasion conversion is above average, average, or below average (e.g., an above average number of surveyed consumers are interested in seeing the film compared to the number of persons wanting to see prior films at a similar point in time).

In the example of FIG. 2, the report creator 210 creates the breakthrough to persuasion conversion report by comparing an upcoming film to all previously released films reflected in a database. In other examples, the report creator 210 creates the report by comparing the upcoming film to a subset of previously released films in the database (e.g., films of the same genre). The example breakthrough to persuasion conversion report created by the report creator 210 may illustrate, for example, that a film is associated with a relatively strong persuasion level given the level of awareness of the film. For example, the report may show, based on the breakthrough and persuasion metrics, that although awareness of the film is not high among consumers, consumers that are aware of the film do want to see it (e.g., an above average persuasion level but suffering from a low breakthrough level). Thus, an increase in awareness-driving marketing could increase the film's box office success because those consumers that are aware of the film do wish to see it. Because in the illustrated example the breakthrough to persuasion report is created by the report creator 210 prior to, and/or shortly after, the film's release, client(s) are able to adjust marketing strategies to improve box office success.

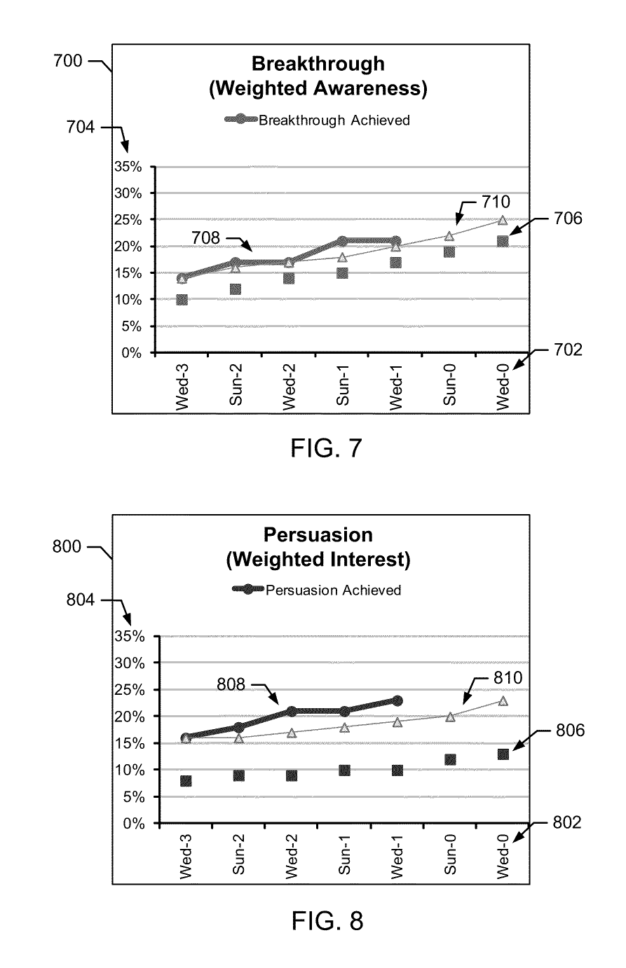

The report creator 210 of the illustrated example creates a breakthrough growth report. The breakthrough growth report illustrates the effectiveness of a marketing campaign based on the growth of breakthrough metrics at certain times prior to a film's release (i.e., over time). Examples of breakthrough growth reports are illustrated in the example reports shown in connection with FIGS. 6 and 7. The breakthrough growth report of the illustrated example shows growth versus genre specific (e.g., a comparison against films of the same genre) and starting point specific norms (e.g., at a same time prior to the film's release). For example, the report creator 210 of the illustrated example may determine a breakthrough metric for a film four times prior to the film's release date. The report creator 210 may calculate the breakthrough growth between each of the four time periods (e.g., between Sunday and Monday, between Monday and Tuesday, between Tuesday and Wednesday). The report creator 210 may calculate the breakthrough growth between the first and the last time period (e.g., between Sunday and Wednesday). Additionally or alternatively, the report creator 210 may calculate the cumulative breakthrough growth by averaging the growth between each time period and/or the growth between the first and the last time period. The report creator 210 of the illustrated example calculates the breakthrough growth between two time periods by comparing a breakthrough metric at a second time period to a breakthrough metric at a first time period. For example, if a first breakthrough metric associated with a film calculated at two weeks prior to the film's release is 30% and a second breakthrough metric associated with film calculated at one week prior to the film's release is 37%, the breakthrough growth from the first week to the second week is 7%.

The report creator 210 of the illustrated example compares the breakthrough growth for the film of interest to the growth of breakthrough metrics for previously released films. The report creator 210 may compare the breakthrough growth to the breakthrough growth of all previously released films for which data is contained in a database and/or may compare the growth to a subset of previously released films for which data is contained in a database (e.g., films of the same genre). The report creator 210 of the illustrated example determines average breakthrough metrics for previously released films and determines average breakthrough growth for the previously released films. These average breakthrough scores may be plotted by the report creator 210 of the illustrated example with the breakthrough scores of the film of interest in a report, for example, the report illustrated in FIG. 7. The example report of FIG. 7 illustrates how the breakthrough growth of the film of interest compares to the average breakthrough growth of previously released films. Additionally, the report creator 210 of the illustrated example indicates if the breakthrough growth of the film of interest is above average, average, or below average when compared to breakthrough growth of previously released films, as shown in connection with the report of FIG. 6. Additionally, the report creator 210 of the illustrated example provides a percentile rank to illustrate that the breakthrough growth of the upcoming film of interest has a breakthrough growth greater than a certain amount of previously released films (e.g., a 50^{th} percentile rank indicates the breakthrough growth is better than 49% of previously released films). The percentile rank may be based on the growth between two time periods prior to a film's release (e.g., the breakthrough growth from three weeks prior to the film's release to two weeks prior to the film's release). The report creator 210 may also provide a cumulative rank by averaging percentile ranks for each time period.

The report creator 210 of the illustrated example also creates a persuasion growth report. The persuasion growth report illustrates the effectiveness of a marketing campaign based on the growth of persuasion metrics at certain times prior to a film's release (i.e., over time). Examples of persuasion growth reports are illustrated in the example reports shown in connection with FIGS. 6 and 8. The persuasion growth report of the illustrated example may show growth versus genre specific (e.g., a comparison against films of the same genre) and starting point specific norms (e.g., at a same time prior to the film's release). For example, the report creator 210 may determine a persuasion metric for a film four times prior to the film's release date. The report creator 210 may calculate the persuasion growth between each of the four time periods (e.g., between Sunday and Monday, between Monday and Tuesday, between Tuesday and Wednesday). The report creator 210 may calculate the persuasion growth between the first and the last time period (e.g., between Sunday and Wednesday). Additionally or alternatively, the report creator 210 may calculate the cumulative persuasion growth by averaging the growth between each time period and/or the growth between the first and the last time period. The report creator 210 of the illustrated example calculates the persuasion growth between two time periods by comparing a persuasion metric at a second time period to a persuasion metric at a first time period. For example, if a first persuasion metric associated with a film calculated at two weeks prior to the film's release is 60% and a second persuasion metric associated with film calculated at one week prior to the film's release is 65%, the persuasion growth from the first week to the second week is 5%.

The report creator 210 of the illustrated example compares the persuasion growth for the film of interest to the growth of persuasion metrics for previously released films. The report creator 210 may compare the persuasion growth to the persuasion growth of all previously released films and/or may compare the growth to a subset of previously released films (e.g., films of the same genre). The report creator 210 of the illustrated example determines average persuasion metrics for previously released films and determines average persuasion growth for the previously released films. These average breakthrough scores may be plotted by the report creator 210 of the illustrated example against the persuasion scores of the film of interest in a report, for example, the report illustrated in FIG. 8. The report illustrates how the persuasion growth of the film of interest compares to the average persuasion growth of previously released films. Additionally, the report creator 210 of the illustrated example indicates if the persuasion growth of the film of interest is above average, average, or below average when compared to persuasion growth of previously released films, as shown in connection with the report of FIG. 6. Additionally, the report creator 210 may provide a percentile rank to rank the persuasion growth of the upcoming film of interest relative to the persuasion growth(s) of previously released films. The percentile rank may be based on the growth between two time periods prior to a film's release (e.g., the persuasion growth from three weeks prior to the film's release to two weeks prior to the film's release). The report creator 210 may also provide a cumulative rank by averaging percentile ranks for each time period.

In the example of FIG. 2, the report creator 210 also creates an overall campaign momentum report to illustrate a marketing campaign's overall success at growing breakthrough and persuasion metrics. To determine the overall campaign momentum, the report creator 210 of the illustrated example averages the breakthrough growth and persuasion growth described above. For example, a film may have a breakthrough growth of 7% and a persuasion growth of 5% between two weeks prior to the film's release and one week prior to the film's release. In such an example, the momentum of the film is 6% (e.g., the average of 7% and 5%). The report creator 210 of the illustrated example compares the persuasion growth for the film of interest to the known growth of persuasion metrics for previously released films. The report creator 210 may compare the momentum of the film of interest to the momentum scores of all previously released films as reflected in a database and/or may compare the momentum to a subset of previously released films as reflected in a database (e.g., films of the same genre). The report creator 210 of the illustrated example determines average momentum scores for previously released films and compares them to the momentum scores of a film of interest. These momentum scores may be compared for use in a momentum report, such as the momentum report shown in connection with FIG. 6. The report creator 210 of the illustrated example indicates if the overall momentum of the film of interest is above average, average, or below average when compared to momentum scores of previously released films. Additionally, the report creator 210 may provide a percentile rank to rank the overall campaign momentum of an upcoming film to be released relative to the overall campaign momentums of previously released films.

The report creator 210 of the illustrated example also creates a diagnostic report to highlight a marketing campaign's communication quality and drivers and/or limiters of interest. A marketing campaign's communication quality illustrates an effectiveness of the marketing campaign at communicating to consumers. Drivers of interest are aspects of the marketing campaign and/or film that increase a consumer's interest in the film. Limiters of interest are aspects of the marketing campaign and/or film that decrease a consumer's interest in the film. Diagnostic data used by the report creator 210 includes, for example, survey data related to factors that make consumers more or less interested in a film, consumers' expectations for the film, consumers' views on advertising related to the film, communication quality, emotional responses, etc. The report creator 210 of the illustrated example displays percentages of surveyed consumers that agree with certain statements related to the film of interest. For example, the diagnostic data report may show that 70% of surveyed consumers feel the genre of the film increases interest in the film. In such an example, this information indicates that an increase in advertising associated with the genre of the film may increase box office success.

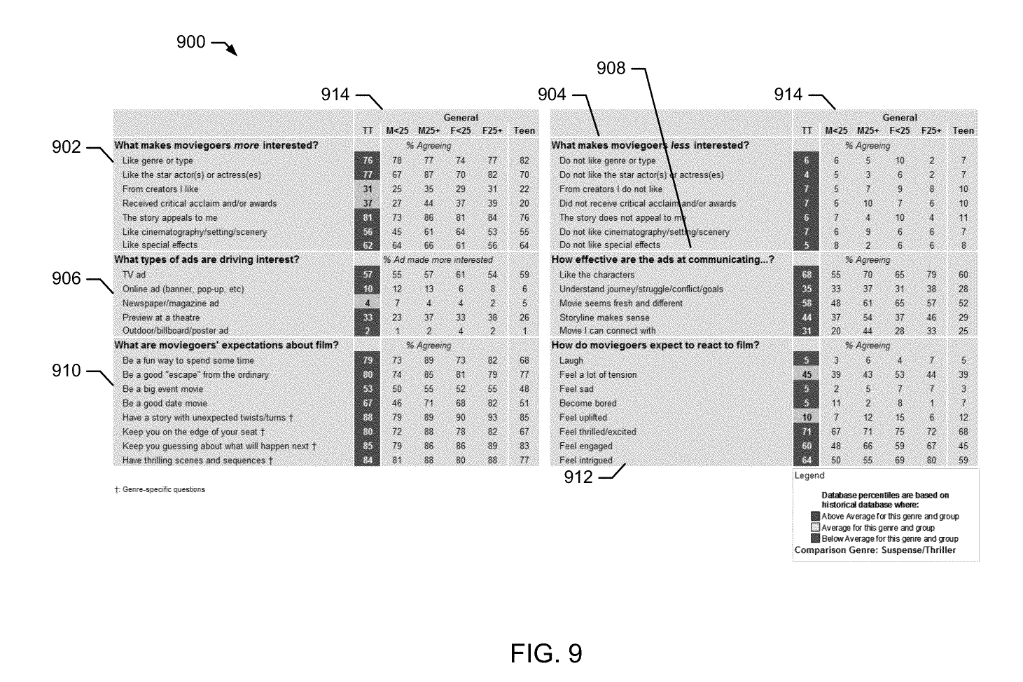

Additionally, the report creator 210 of the illustrated example compares the diagnostic data for a film of interest to diagnostic data of previously released films. For example, the report creator 210 may indicate that a diagnostic score is above average, average, or below average when compared to diagnostic scores of previously released films at the same time relative to the film release date (e.g., a score of 70% regarding surveyed consumers' interest in the genre of the film may be above average when compared to the scores of previously released films). The report creator 210 may compare the diagnostic data of the film of interest to the diagnostic data of all previously released films reflected in a database (e.g., a database corresponding to films released in the last 5 years) and/or may compare the diagnostic data to a subset of those previously released films (e.g., films of the same genre). The report creator 210 may compare the diagnostic data of a particular demographic group of surveyed consumers to diagnostic data of the same particular demographic group for previously released films (e.g., a comparison may be made between females over the age of 25). An example diagnostic report is illustrated in FIG. 9.

The report creator 210 of the illustrated example also creates a report based on online data to identify how much discussion exists about a film of interest and what consumers are taking away from a marketing campaign for the film of interest. The report creator 210 of the illustrated example evaluates, for example, amounts of online conversation about a film, tone of online conversation, sentiment and/or content of online discussion. The report creator 210 of the illustrated example uses the online data received by the database 208 via the interface 202 to create the online data report. For example, the report creator 210 may illustrate a total online conversation level for an upcoming film to be released. The total online conversation level may be, for example, the total number of mentions in an online forum during a certain time period prior to the film's release.

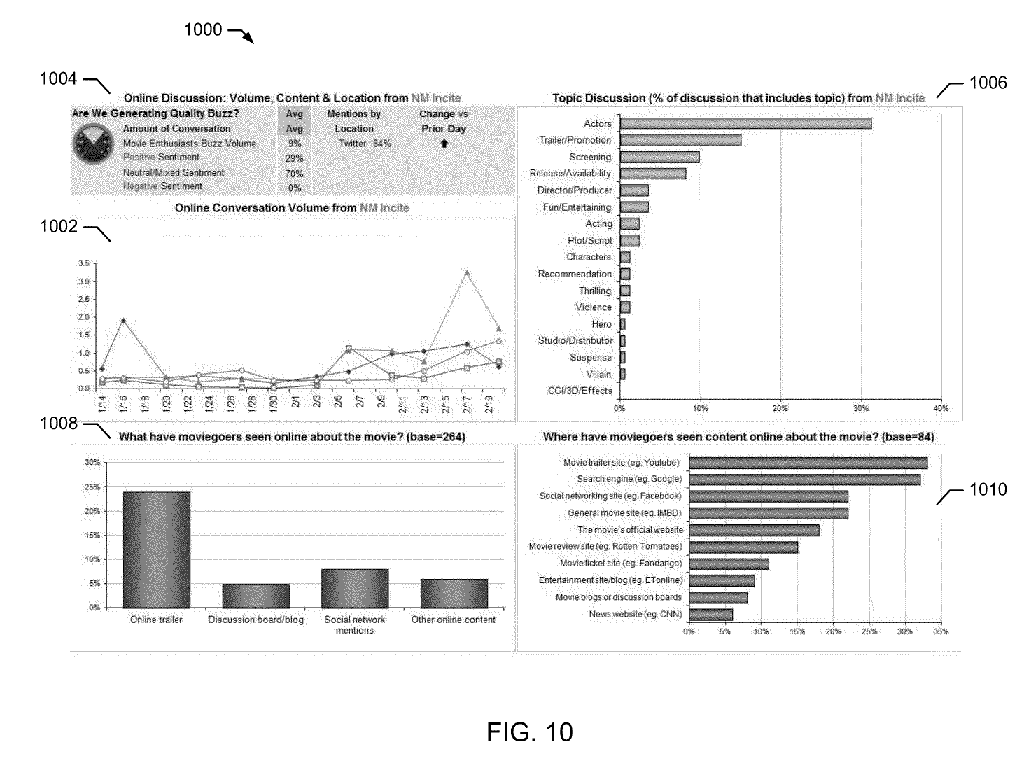

The report creator 210 may, for example, compare the total online conversation for the film to one or more of the total online conversation levels for other films about to be released and/or the total online conversation levels for previously released films. The comparison may be made against all previously released films reflected in a database (e.g., a database corresponding to films released in the last 5 years) and/or against a subset of those previously released films (e.g., films of the same genre). Additionally or alternatively, the report creator 210 may illustrate the amounts of the total conversation falling into particular tone categories. For example, the report creator 210 may show the amount of online conversations qualifying as positive, neutral, and/or negative in tone. The report creator 210 of the illustrated example compares tone-specific conversation levels to the tone-specific conversation levels of previously released films (e.g., all previously released films in a database and/or previously released films of a subset of interest). An example online data report created by the report creator 210 of the illustrated example is illustrated in FIG. 10.

In the example of FIG. 2, the report creator 210 also illustrates the amount of the total conversation that was collected from a specific online site (e.g., message boards, blogs, social networking cites, etc.). The report creator 210 of the illustrated example also compares these amounts to historical data for previously released films. As described above, the online conversations may be categorized based on topic(s) of discussion (e.g., an actor, a director, an advertisement, a genre-specific quality, etc.). The report creator 210 of the illustrated example illustrates the amount of total online conversation categorized in each of these topics. For example, the report creator 210 might illustrate that 50% of the online discussion for an upcoming film involves an actor, 25% of the online discussion involves the words “scary” and “frightening,” and 25% of the online discussion involves an advertisement. The report creator 210 of the illustrated example compares the amounts of topic-related conversation levels to amounts of topic-related conversation levels for previously released films.

Additionally or alternatively, the report creator 210 of the illustrated example creates an advertisement report using advertisement data from the database 208. The advertisement report may include the number of advertisement occurrences for an upcoming film that were available for consumer exposure prior to the film's release. For example, the report creator 210 may show that a film has had 100 advertisement occurrences in the week prior to the film's release. The report creator 210 of the illustrated example sends the created reports to the database 208 to be stored and/or to the report sender 212 to be sent to client(s).

The report sender 212 of the illustrated example sends the report(s) created by the report creator 210 to a client, for example, the client 114 of FIG. 1. The report sender 212 of the illustrated example receives the created reports from the report creator 210 and/or accesses the created reports that have been stored in the database 208.

While an example manner of implementing the example campaign monitor 102 of FIG. 1 is illustrated in FIG. 2, one or more of the elements, processes and/or devices illustrated in FIG. 2 may be combined, divided, re-arranged, omitted, eliminated and/or implemented in any other way. Further, the example interface 202, the example breakthrough calculator 204, the example persuasion calculator 206, the example database 208, the example report creator 210, the example report sender 212, and/or, more generally, the example campaign monitor 102 of FIG. 2 may be implemented by hardware, software, firmware and/or any combination of hardware, software and/or firmware. Thus, for example, any of the example interface 202, the example breakthrough calculator 204, the example persuasion calculator 206, the example database 208, the example report creator 210, the example report sender 212, and/or, more generally, the example campaign monitor 102 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the system or apparatus claims of this patent are read to cover a purely software and/or firmware implementation, at least one of the example interface 202, the example breakthrough calculator 204, the example persuasion calculator 206, the example database 208, the example report creator 210, the example report sender 212, and/or the example campaign monitor 102 are hereby expressly defined to include a tangible computer readable medium such as a memory, DVD, CD, etc. storing the software and/or firmware. Further still, the example campaign monitor 102 of FIG. 2 may include one or more elements, processes and/or devices in addition to, or instead of, those illustrated in FIG. 2, and/or may include more than one of any or all of the illustrated elements, processes and devices.

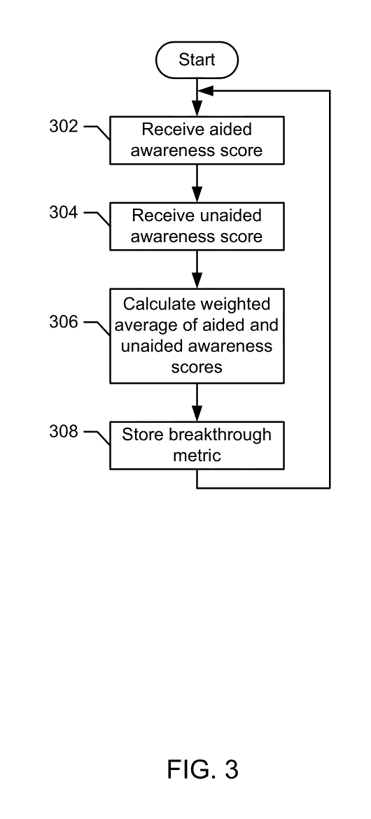

Flowcharts representative of example machine readable instructions for implementing the example campaign monitor 102 of FIG. 2 are shown in FIGS. 3-5. In these examples, the machine readable instructions comprise a program for execution by a processor such as the processor 602 shown in the example computing device 600 discussed below in connection with FIG. 6. The program may be embodied in software stored on a tangible computer readable medium such as a CD-ROM, a floppy disk, a hard drive, a digital versatile disk (DVD), or a memory associated with the processor 602, but the entire program and/or parts thereof could alternatively be executed by a device other than the processor 602 and/or embodied in firmware or dedicated hardware. Further, although the example program is described with reference to the flowcharts illustrated in FIGS. 3-5, many other methods of implementing the example campaign monitor 102 may alternatively be used. For example, the order of execution of the blocks may be changed, and/or some of the blocks described may be changed, eliminated, or combined.

As mentioned above, the example processes of FIGS. 3-5 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 3-5 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

A flowchart representative of example machine readable instructions for implementing the example breakthrough calculator 204 of FIG. 2 is shown in FIG. 3. The breakthrough calculator 204 of the illustrated example is provided to calculate breakthrough metrics to be used in evaluating the effectiveness of a marketing campaign for an upcoming film release. The breakthrough metrics calculated by the breakthrough calculator 204 of the illustrated example may be more predictive of box office success than other marketing scores and allow clients to adjust marketing techniques prior to, and/or shortly after, the release of the film to ensure greater box office success.

Initially, the breakthrough calculator 204 receives an aided awareness score from a central facility, such as the central facility 108 of FIG. 1, via an interface, such as the interface 202 of FIG. 2 (block 302). The aided awareness score reflects a percentage of consumers claiming they are aware of a title of the upcoming film when prompted with a list. The media measurement system(s) 104 of FIG. 1 may be used to collect survey data and/or determine an aided awareness score to be used by the breakthrough calculator 204. Additionally, the breakthrough calculator 204 of the illustrated example receives an unaided awareness score from the central facility via the interface (block 304). The unaided awareness score reflects a percentage of consumers volunteering that they are aware of the film unprompted (e.g., without the use of a list). The media measurement system(s) 104 of FIG. 1 may be used to collect survey data and/or determine an unaided awareness score to be used by the breakthrough calculator 204.

The breakthrough calculator 204 of the illustrated example calculates a breakthrough metric (block 306). The breakthrough calculator 204 calculates the breakthrough metric by calculating a weighted average of the aided and unaided awareness scores. For example, the breakthrough calculator 204 may sum the product of 25% and the aided awareness score with the product of 75% and the unaided awareness score. The breakthrough metric may be based on all consumers surveyed and/or based on a subset of survey respondents (e.g., on certain demographic groups such as, for example, males over 25 and females over 25). Additionally, in the example of FIG. 3, the breakthrough metric may be calculated by the breakthrough calculator 204 at selected times prior to a film's release. For example, the breakthrough metric may be calculated each Wednesday and Sunday for the four weeks prior to the film's release. The breakthrough calculator 204 of the illustrated example stores the breakthrough metrics in a database, for example, the database 208 of FIG. 2, to be stored for use in report creation (block 308). Control then returns to block 302.

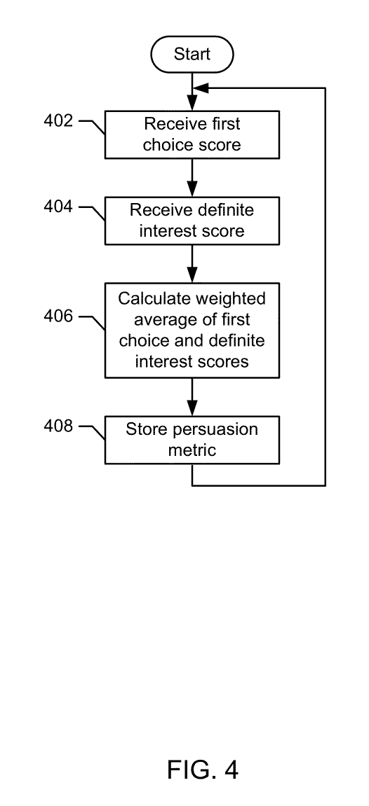

A flowchart representative of example machine readable instructions for implementing the example persuasion calculator 206 of FIG. 2 is shown in FIG. 4. The persuasion calculator 206 of the illustrated example is provided to calculate persuasion metrics to be used in evaluating the effectiveness of a marketing campaign for an upcoming film release. The persuasion metrics calculated by the persuasion calculator 206 of the illustrated example may be more predictive of box office success than other marketing scores and allow clients to adjust marketing techniques prior to, and/or shortly after, the release of the film to ensure greater box office success.

Initially, the persuasion calculator 206 receives a first choice score from a central facility, such as the central facility 108 of FIG. 1, via an interface, such as the interface 202 of FIG. 2 (block 402). The first choice score reflects a percentage of consumers volunteering that the film is their first choice to see in theaters. The media measurement system(s) 104 of FIG. 1 may be used to collect survey data and/or determine a first choice score to be used by the persuasion calculator 206. Additionally, the persuasion calculator 206 of the illustrated example receives a definite interest score from the central facility via the interface (block 404). The definite interest score reflects a percentage of consumers declaring that they are definitely interested in seeing the film when asked about the film directly. The survey data, the first choice score, and/or the definite interest scores to be used by the persuasion calculator 206 may be collected by the media measurement system(s) 104 of FIG. 1.

The persuasion calculator 206 of the illustrated example calculates a persuasion metric (block 406). The persuasion calculator 206 calculates the persuasion metric by calculating a weighted average of the first choice and definite interest scores. For example, the persuasion calculator 206 may sum the product of 75% and the first choice score with the product of 25% and the definite interest score. The persuasion metric may be based on all consumers surveyed and/or based on a subset of survey respondents (e.g., on certain demographic groups such as, for example, males over 25 and females over 25). Additionally, in the example of FIG. 4, the persuasion metric may be calculated by the persuasion calculator 206 at selected times prior to a film's release. For example, the persuasion metric may be calculated each Wednesday and Sunday for the four weeks prior to the film's release. The persuasion calculator 206 of the illustrated example stores the persuasion metrics in a database, for example, the database 208 of FIG. 2, to be stored for use in report creation (block 408). Control then returns to block 402.

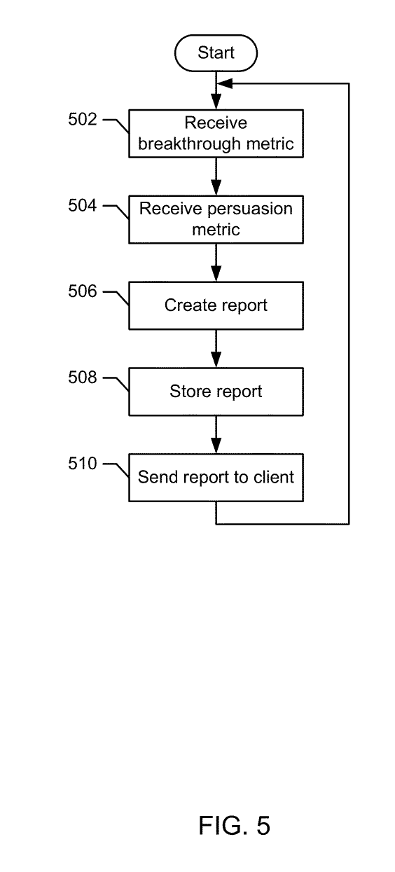

A flowchart representative of example machine readable instructions for implementing the example report creator 210 of FIG. 2 is shown in FIG. 5. The report creator 210 of the example campaign monitor 102 of FIG. 2 is used to create reports to illustrate the effectiveness of a marketing campaign associated with an upcoming release of a film. Initially, the report creator 210 of the illustrated example receives breakthrough metrics stored in a database, for example the database 208 of FIG. 2 (block 502). The report creator 210 may receive breakthrough metrics for a specific upcoming film, for all previously released films reflected in a database (e.g., films released in the last 10 years), and/or previously released films of a specific genre (e.g., films in the same genre as the film of interest). Additionally, the report creator 210 may receive breakthrough metrics for a film at a specific point in time prior to the film's release (e.g., one week before the release date). The example report creator 210 receives persuasion metrics stored in the database (block 504). The report creator 210 may receive persuasion metrics for a specific upcoming film, for all previously released films reflected in a database, and/or previously released films of a specific genre. Additionally, the report creator 210 may receive persuasion metrics for a film at a specific point in time prior to the film's release (e.g., one week before the release date).

The report creator 210 of the illustrated example then uses the breakthrough and/or persuasion metrics to create report(s) to illustrate the effectiveness of the marketing campaign associated with an upcoming film (block 506). For example, the report creator 210 may create a breakthrough to persuasion conversion report to compare persuasion levels to breakthrough levels at a set point in time prior to a film's release. Additionally, the report creator 210 may provide a historical perspective in the breakthrough to persuasion conversion report by comparing the breakthrough and persuasion scores of the film to the scores of previously released films (e.g., all previously released films reflected in a database and/or previously released films of a certain genre).

The report creator 210 may create a breakthrough growth report and/or a persuasion growth report to illustrate growth of consumers' awareness and interest in the upcoming film release. The report creator 210 determines and/or illustrates breakthrough and/or persuasion growth by comparing breakthrough and/or persuasion scores between two time periods prior to the film's release. Additionally, the report creator 210 may provide a historical perspective in the breakthrough and/or persuasion growth report(s) by comparing the breakthrough and/or persuasion growth of the film to the growth of previously released films (e.g., all previously released films reflected in a database and/or previously released films of a certain genre).

Additionally, the report creator 210 of the illustrated example may create an overall campaign momentum report to illustrate the overall campaign momentum of an upcoming film. To create the overall campaign momentum report, the example report creator 210 averages the breakthrough growth and persuasion growth of the film. Additionally, the report creator 210 may provide a historical perspective in the campaign momentum report by comparing the campaign momentum of the film to the campaign momentum of previously released films (e.g., all previously released films and/or previously released films of a certain genre).

Additionally or alternatively, the report creator 210 may receive survey and/or tracking data provided directly to the database from a central facility, such as the central facility 108 of FIG. 1. Such survey and/or tracking data may be used by the report creator 210 of the illustrated example to create diagnostic data reports, online tracking reports and/or advertisement reports. For example, the report creator 210 may create a report illustrating diagnostic data such as consumer expectations for a film of interest, marketing communication quality related to the film of interest, consumers' expected emotional responses to the film of interest, etc. For example, the report creator 210 may also create reports illustrating an amount of online conversation for a film, a type of online conversation for a film, a tone of online conversation for a film, and/or a number of advertisements shown for a film. The report creator 210 may include, for each of these reports, a historical perspective to compare the upcoming film to previously released films (e.g., all previously released films reflected in a database and/or previously released films of a certain genre).

At block 508, the report creator 210 of the illustrated example sends the created report(s) to the database to be stored. At block 510, the report creator 210 of the illustrated example sends the created report(s) to the client(s) via a report sender, for example, the report sender 212 of FIG. 2. Control then returns to block 502.

FIG. 6 is an example report 600 created by the example campaign monitor 102 of FIG. 1. The report 600 of the illustrated example includes an overall campaign momentum 602, a breakthrough growth 604, a persuasion growth 606, and a breakthrough to persuasion conversion 608 in a scoring grid 610. The report 600 of the illustrated example is created using breakthrough metrics and persuasion metrics calculated for a film of interest (e.g., the film included in a consumer survey). The breakthrough metrics and persuasion metrics are compared to metrics of previously released films to determine the overall campaign momentum 602, the breakthrough growth 604, the persuasion growth 606, and the breakthrough to persuasion conversion 608. The breakthrough and persuasion metrics of the illustrated example are shown for surveyed consumers as a whole and for groups of surveyed consumers (e.g., males under 25, males over 25, females under 25, females over 25, and teens). The scoring grid 610 provides scores for the overall campaign momentum 602, the breakthrough growth 604, the persuasion growth 606, and the breakthrough to persuasion conversion 608 based on each of the groups (e.g., the total surveyed group, males under 25, males over 25, females under 25, females over 25, and teens). In the illustrated example, the film of interest is compared to previously released films of the same genre. In other examples, the film of interest may additionally or alternatively be compared to all previously released films, films of the same genre, etc.

The breakthrough to persuasion conversion 608 measures how strong interest levels for a film are given a determined level of awareness by comparing the breakthrough and persuasion metrics for the film to breakthrough and persuasion metrics from previous films. For example, a persuasion metric of a film of interest is compared to an average persuasion metric of previously released films having a same or similar breakthrough metric (e.g., a breakthrough metric in a same range of breakthrough metrics). The film of the illustrated example has a persuasion score of 66% and a breakthrough score of 75% at two weeks prior to the film's release. Comparing the example breakthrough and persuasion scores to the breakthrough and persuasion scores of example previously released films at two weeks prior to their respective release dates indicates that the film of interest scores above average in each demographic group (e.g., all surveyed consumers, males under 25, males over 25, females under 25, females over 25, and teens). In the illustrated example, each box at the cross-section of the breakthrough to persuasion conversion 608 in the scoring grid 610 contains “Abv,” indicating that the scores are above average for the genre and for the particular demographic group. Alternatively, the breakthrough to persuasion conversion 608 may indicate that the breakthrough to persuasion conversion is “Avg” to indicate that the value is average, “Blw” to indicate that the value is below average, or any other indication.

The persuasion growth 606 illustrates the cumulative growth of the persuasion metrics for the film of interest over a time period (e.g., the time prior to the film's release). The persuasion growth 606 of the illustrated example illustrates the overall persuasion growth (e.g., from a first tracking date to the current tracking date) and the persuasion growth over the most recent tracking period (e.g., from the previous tracking date to the current tracking date). The scoring grid 610 contains the persuasion growth scores for each of the demographic groups. In the illustrated example, the prior day persuasion scores (e.g., the previous tracking date) for the film of interest for the surveyed group as a whole is 17% and for men under 25 is 14%. The current day persuasion growth score (e.g., the current tracking date) for the surveyed group as a whole is 19% and for men under 25 is 17%. The scoring grid 610 shows that the growth from the prior day to the current day for the surveyed group as a whole is average (e.g., the 2% change is average when compared to previously released films), while the growth from the prior day to the current day for men under 25 is above average (e.g., the 3% change is above average when compared to previously released films). The scoring grid 610 also shows that the cumulative persuasion growth for the surveyed group as a whole is above average while the cumulative persuasion growth for men under 25 is average. The persuasion growth 606 also shows what sources of advertising most increase interest in the film. For example, of all surveyed consumers, 20% found TV to be the most influential source in increasing interest in the film.

The breakthrough growth 604 illustrates the cumulative growth of the breakthrough metrics for the film of interest over the time prior to the film's release. The breakthrough growth 604 of the illustrated example illustrates the overall breakthrough growth (e.g., from a first tracking date to the current tracking date) and the breakthrough growth over the most recent tracking period (e.g., from the previous tracking date to the current tracking date). The scoring grid 610 contains the breakthrough growth scores for each of the demographic groups. For example, the prior day breakthrough scores (e.g., the previous tracking date) for the film of interest for the surveyed group as a whole is 18% and for men under 25 is 16%. The current day breakthrough growth score (e.g., the current tracking date) for the surveyed group as a whole is 19% and for men under 25 is 18%. The scoring grid 610 shows that the growth from the prior day to the current day for the surveyed group as a whole is average (e.g., the 1% change is average when compared to previously released films), and the growth from the prior day to the current day for men under 25 is average (e.g., the 2% change is average when compared to previously released films). The scoring grid 610 also shows that the cumulative breakthrough growth for the surveyed group as a whole is above average and the cumulative breakthrough growth for men under 25 is also above average. The breakthrough growth 604 also shows what sources of advertising most increase awareness of the film. For example, of all surveyed consumers, 52% found TV to be the most influential source in increasing awareness of the film.

The overall campaign momentum 602 illustrates the cumulative growth of the average of the breakthrough growth and persuasion growth. The overall campaign momentum 602 of the illustrated example compares the current momentum to the momentum of the previous day and compares the current momentum to the momentum of the first tracking date. For example, the scoring grid 610 shows that the overall campaign momentum is above average for the surveyed group as a whole from the prior day to the current tracking day.

FIG. 7 illustrates another example report 700 created by the campaign monitor 102 of FIG. 1. The report 700 of the illustrated example illustrates breakthrough growth for a film of interest based on all surveyed consumers. In other examples, the report 700 may be based on a group of surveyed consumers (e.g., women under 25). The x-axis of the report 700 of the illustrated example shows the time periods 702 for the tracked data (e.g., the Wednesday three weeks prior to the film's release, the Sunday two weeks prior to the film's release, etc.) The y-axis of the report 700 of the illustrated example shows the breakthrough score values. The data points 706 show the historical breakthrough of films in the same genre as the film of interest (e.g., the average breakthrough scores for previously released films of the same genre). The line 708 shows the breakthrough scores of the film of interest. The line 710 shows the average breakthrough scores for all previously released films. In the example of FIG. 7, the line 708 shows that the breakthrough score of the film of interest is above the breakthrough scores of the previously released films of the same genre and of previously released films as a whole on the Sunday one week prior to the film's release. As shown in the example of FIG. 7, the breakthrough scores for the film of interest will need to grow to approximately 25% by the Wednesday prior to the release of the film to stay on track with the averages of previously released films.

FIG. 8 illustrates another example report 800 created by the campaign monitor 102 of FIG. 1. The report 800 of the illustrated example illustrates persuasion growth for a film of interest based on all surveyed consumers. In other examples, the report 800 may be based on a subset of surveyed consumers (e.g., women under 25). The x-axis of the report 800 of the illustrated example shows the time periods 802 for the tracked data. The y-axis of the report 800 of the illustrated example shows persuasion score values. The data points 806 shows the historical persuasion of films in the same genre as the film of interest (e.g., the average persuasion scores for previously released films of the same genre). The line 808 shows the persuasion scores of the film of interest. The line 810 shows the average persuasion scores for all previously released films reflected in a database. In the example of FIG. 8, the line 808 shows that the persuasion score is above the persuasion scores of the previously released films of the same genre and of previously released films as a whole on the Sunday one week prior to the film's release. As shown in the example of FIG. 8, the persuasion scores for the film of interest will need to grow to approximately 23% by the Wednesday pror to the release of the film to stay on track with the averages of previously released films.

FIG. 9 is another example report 900 created by the example campaign monitor 102 of FIG. 1. The report 900 of the illustrated example reports on what makes consumers (e.g., moviegoers) more interested in a film 902, what makes consumers less interested in a film 904, what types of advertising are driving (e.g., increasing) interest 906, how effective the advertisements are at communicating 908, what consumers' expectations for the film are 910, and how consumers expect to react to the film 912. The report 900 of the illustrated example is created using diagnostic data collected from consumer surveys. The diagnostic data for the film of interest is compared to diagnostic data of previously released films to indicate what makes consumers more interested in a film 902, what makes consumers less interested in a film 904, what types of advertising are driving interest 906, how effective the advertisements are at communicating 908, what consumers' expectations for the film are 910, and how consumers expect to react to the film 912. The diagnostic data, as used in the illustrated example, is based on surveyed consumers as a whole, as well as a group of surveyed consumers (e.g., males under 25, males over 25, females under 25, females over 25, and teens). The scoring grid 914 provides scores for what makes consumers more interested in a film 902, what makes consumers less interested in a film 904, what types of advertising are driving interest 906, how effective the advertisements are at communicating 908, what consumers' expectations for the film are 910, and how consumers expect to react to the film 912 based on each of these groups (e.g., the total surveyed group, males under 25, males over 25, females under 25, females over 25, and teens). In the illustrated example, the film of interest is compared to previously released films of the same genre. In other examples, the film of interest may additionally or alternatively be compared to all previously released films reflected in a database.

In the illustrated example, when asked what makes consumers more interested in the film of interest 902, consumers could select one or more of the genre or type, the star actor(s) or actress(es), the creators, critical acclaim, etc. The scoring grid 914 of the illustrated example shows an amount of consumers agreeing that a certain category or characteristic increased their interest in the film. For example, the cross-section of “like genre or type” and the total (i.e., “TT”) shows that 76% of all surveyed consumers agree that the genre or type of the film makes them more interested in the film. The scoring grid 914 shows that, for example, 74% of females under 25 agree that the genre or type makes them more interested in the film. The scoring grid 914 of the illustrated example additionally color-codes each total percentage to show whether that percentage is above average, average, or below average when compared with previously released films of the same genre. In other examples, the percentages may be compared against all previously released films reflected in a database. The percentages may be colored green to represent above average scores, may be colored yellow to represent average scores, and may be colored red to represent below average scores.

In the illustrated example, when asked what makes consumers less interested in the film of interest 904, consumers could select one or more of the genre or type, the star actor(s) or actress(es), the creators, critical acclaim, etc. The scoring grid 914 of the illustrated example shows an amount of consumers agreeing that a certain category decreased their interest in the film. For example, the cross-section of “like genre or type” and the total shows that 6% of all surveyed consumers agree that the genre or type of the film makes them less interested in the film. The scoring grid 914 shows that, for example, 10% of females under 25 agree that the genre or type makes them less interested in the film. The scoring grid 914 of the illustrated example additionally color-codes each total percentage to show whether that percentage is above average, average, or below average when compared with previously released films of the same genre.

In the illustrated example, when asked what types of ads drive consumer interest 906, consumers could select one or more of TV ads, online ads, newspaper/magazine ads, previews at a theatre, or outdoor/billboard/poster ads. The scoring grid 914 of the illustrated example shows an amount of consumers agreeing that a certain category drives their interest in the film. For example, the cross-section of “TV ads” and the total shows that 57% of all surveyed consumers agree that TV ads drive their interest in the film. The scoring grid 914 shows that, for example, 61% of females under 25 agree that TV ads drive their interest in the film. The scoring grid 914 of the illustrated example additionally color-codes each total percentage to show whether that percentage is above average, average, or below average when compared with previously released films of the same genre.

In the illustrated example, when asked how effective the advertisements are at communicating 908, consumers could select one or more categories, such as that they like the characters, they understand a journey/struggle/conflict/goal, the film seems fresh and different, etc. The scoring grid 914 of the illustrated example shows an amount of consumers agreeing that the advertisements were effective at communicating each category. For example, the cross-section of “like the character” and the total shows that 68% of all surveyed consumers agree that, based on the advertisements, they like the characters in the film. The scoring grid 914 shows that, for example, 65% of females under 25 agree that, based on the advertisements, they like the characters in the film. The scoring grid 914 of the illustrated example additionally color-codes each total percentage to show whether that percentage is above average, average, or below average when compared with previously released films of the same genre.

In the illustrated example, when asked how they expect to react to the film 912, consumers could select one or more categories, such as laugh, feel a lot of tension, feel sad, etc. The scoring grid 914 of the illustrated example shows an amount of consumers agreeing that a certain category would reflect how they expect to react to the film. For example, the cross-section of “laugh” and the total shows that 5% of all surveyed consumers agree that they expect to laugh during the film. The scoring grid 914 shows that, for example, 4% of females under 25 agree that they expect to laugh during the film. The scoring grid 914 of the illustrated example additionally color-codes each total percentage to show whether that percentage is above average, average, or below average when compared with previously released films of the same genre.

The report 900 of the illustrated example may allow marketing campaigns for the film of interest to be adjusted based on the information displayed in the report 900. For example, if the report 900 shows that TV advertisements are the most effective advertising at driving consumer interest, the marketing campaign may increase TV advertisements to increase box office success.

FIG. 10 is another example report 1000 created by the example campaign monitor 102 of FIG. 1. The report 1000 of the illustrated example is based on online survey data and reflects a volume of online conversation 1002, quality of online conversation 1004, topics of discussion of online conversation 1006, what consumers have seen online about the film 1008, and where consumers have seen content online about the film 1010.

The volume of online conversation 1002 of the illustrated example is a visual representation of the amount of online conversation for a film of interest along with the amount of online conversation for other films to be released over the time prior to the films' release.

The quality of online conversation 1004 of the illustrated example shows whether the film is generating quality buzz (e.g., is the film being mentioned online and are the online mentions positive in tone). The quality of online conversation 1004 of the illustrated example compares the volume of online conversation at a certain time prior to the film's release to previously released films and determines if the volume of online conversation for the film of interest is above average, average, or below average. The quality of online conversation 1004 of the illustrated example shows the amount of online conversation determined to be positive in sentiment (e.g., coded as positive). For example, 29% of the online conversation for the film of interest was determined to be positive in tone. The quality of online conversation 1004 of the illustrated example also shows that an amount of online conversation came from a particular online location, such as a social networking site. The topics of discussion of online conversation 1006 identifies the topic to which the online conversation relates. For example, the topics of discussion 1006 show what amounts of online conversation relate to actors, trailers, acting, plot, etc. For example, the topics of discussion 1006 of the illustrated example show that over 30% of online conversation for the film of interest related to actors in the film. What consumers have seen online about the film 1008 illustrates amounts of consumers that have seen certain categories of content related to the film online. For example, 24% of consumers have seen a trailer for the film of interest online. The location of viewed online content 1010 illustrates amounts of consumers that have seen content related to the film at certain online locations. The locations include, for example, movie trailer sites, search engines, social networking sites, general movie sites, etc. For example, 34% of consumers saw content related to the film of interest on a movie trailer site.

FIG. 11 is a block diagram of an example processing system 1100 capable of executing the instructions of FIGS. 3-5 to implement the example breakthrough calculator 204, the example persuasion calculator 206, the example report creator 210, the example campaign monitor 102 of FIG. 2, and/or the system of FIG. 1. The processing system 1100 can be, for example, a server, a personal computer, an Internet appliance, or any other type of computing device.

The system 1100 of the instant example includes a processor 1112 such as a general purpose programmable processor. The processor 1112 includes a local memory 1114, and executes coded instructions 1116 present in the local memory 1114 and/or in another memory device. The processor 1112 may execute, among other things, the machine readable instructions represented in FIGS. 3-5. The processor 1112 may be any type of processing unit, such as one or more Intel® and/or ARM® microprocessors, and/or one or more PICO microcontrollers, etc. Of course, other processors from other families are also appropriate.

The processor 1112 is in communication with a main memory including a volatile memory 1118 and a non-volatile memory 1120 via a bus 1122. The volatile memory 1118 may be implemented by Static Random Access Memory (SRAM), Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1120 may be implemented by flash memory and/or any other desired type of memory device. Access to the main memory 1118, 1120 is typically controlled by a memory controller (not shown).

The processing system 1100 also includes an interface circuit 1124. The interface circuit 1124 may be implemented by any type of interface standard, such as an Ethernet interface, a universal serial bus (USB), a peripheral component interconnect (PCI), and/or a third generation input/output (3GIO) interface.

One or more input devices 1126 are connected to the interface circuit 1124. The input device(s) 1126 permit a user to enter data and commands into the processor 1112. The input device(s) can be implemented by, for example, a keyboard, a mouse, a touchscreen, a track-pad, a trackball, an isopoint and/or a voice recognition system.

One or more output devices 1128 are also connected to the interface circuit 1124. The output devices 1128 can be implemented, for example, by display devices (e.g., a liquid crystal display, a cathode ray tube display (CRT)), by a printer and/or by speakers. The interface circuit 1124, thus, typically includes a graphics driver card.

The interface circuit 1124 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The processing system 1100 also includes one or more mass storage devices 1130 for storing machine readable instructions and data. Examples of such mass storage devices 1130 include floppy disk drives, hard drive disks, compact disk drives, digital versatile disk (DVD) drives, flash drives, etc.

The coded instructions 1132 of FIGS. 3-5 may be stored in the mass storage device 1130, in the volatile memory 1118, in the non-volatile memory 1120, in the local memory 1114 and/or on a removable storage medium, such as a CD or DVD 1132.

As an alternative to implementing the methods and/or apparatus described herein in a system such as the processing system of FIG. 11, the methods and or apparatus described herein may be embedded in a structure such as a processor and/or an ASIC (application specific integrated circuit).

In examples disclosed herein, breakthrough metrics and/or persuasion metrics are used to create report(s) to illustrate an effectiveness of a marketing campaign associated with a release of an upcoming film. The breakthrough metrics and/or persuasion metrics provide increased predictability of box office success and enable a client to adjust marketing strategies prior to, and/or shortly after, the release of the film to improve box office success.

Although certain methods, apparatus, systems, and/or articles of manufacture have been described herein, the scope of coverage of this patent is not limited thereto. On the contrary, this patent covers all methods, apparatus, and articles of manufacture fairly falling within the scope of the claims of this patent either literally or under the doctrine of equivalents.

What is claimed is:

1. A method to monitor a marketing campaign comprising:
calculating, with a processor, a breakthrough metric based on a weighted average of an aided awareness score and an unaided awareness score, the breakthrough metric indicating a level of awareness of a film among consumers; and
calculating a persuasion metric based on a weighted average of a first choice score and a definite interest score, the persuasion metric indicating a level of interest in the film among consumers; and
generating a report reflecting an effectiveness of the marketing campaign based on the breakthrough metric and the persuasion metric.

2. The method of claim 1, wherein the aided awareness score is a first percentage of persons aware of the film when prompted with a list of films and the unaided awareness score is a second percentage of persons aware of the film unprompted.

3. The method of claim 2, wherein the weighted average comprises a sum of a first product of 25% and the aided awareness score and a second product of 75% and the unaided awareness score.

4. The method of claim 2, wherein the first choice score is a third percentage of persons declaring the film to be a first choice without prompting and the definite interest score is a fourth percentage of persons declaring interest in the film when given a title of the film directly.

5. The method of claim 4, wherein the weighted average comprises a sum of a first product of 75% and the first choice score and a second product of 25% and the definite interest score.

6. A system to monitor a marketing campaign comprising:
a breakthrough calculator to calculate a breakthrough metric based on an aided awareness score and an unaided awareness score, the breakthrough metric indicating a level of awareness of a film among consumers based on the marketing campaign; and
a persuasion calculator to calculate a persuasion metric based on a first choice score and a definite interest score, the persuasion metric indicating a level of interest in the film among consumers based on the marketing campaign.

7. The system of claim 6, wherein the aided awareness score is a first percentage of survey respondents aware of the film when prompted with a film name and the unaided awareness score is a second percentage of survey respondents aware of the film without being prompted with the film name.

8. The system of claim 7, wherein the breakthrough calculator is to calculate the breakthrough metric by computing a weighted average, the weighted average comprising a first product of a first weighting factor and the aided awareness score and a second product of a second weighting factor and the unaided awareness score.

9. The system of claim 7, wherein the first choice score is a third percentage of survey respondents declaring the film to be a first choice without being prompted with the film name and the definite interest score is a fourth percentage of survey respondents declaring interest in the film when given the title of the film.

10. The system of claim 9, wherein the persuasion calculator is to calculate the persuasion metric based on a first product of a third weighting factor and the first choice score and a second product of a fourth weighting factor and the definite interest score.

11. The system of claim 6, further comprising a database to store the breakthrough metric and the persuasion metric.

12. The system of claim 11, further comprising a report creator to create a report based on the breakthrough metric and the persuasion metric.

13. A tangible computer-readable medium comprising instructions that, when executed, cause a computing device to at least:
calculate a breakthrough metric based on a weighted average of an aided awareness score and an unaided awareness score, the breakthrough metric indicating a level of awareness of a film among consumers; and
calculate a persuasion metric based on a weighted average of a first choice score and a definite interest score, the persuasion metric indicating a level of interest in the film among consumers; and
generate a report reflecting an effectiveness of the marketing campaign based on the breakthrough metric and the persuasion metric.

14. The tangible computer-readable medium of claim 13, wherein the aided awareness score is a first percentage of persons aware of the film when prompted with a list of films and the unaided awareness score is a second percentage of persons aware of the film unprompted.

15. The tangible computer-readable medium of claim 14, wherein the weighted average comprises a sum of a first product of 25% and the aided awareness score and a second product of 75% and the unaided awareness score.

16. The tangible computer-readable medium of claim 14, wherein the first choice score is a third percentage of persons declaring the film to be a first choice without prompting and the definite interest score is a fourth percentage of persons declaring interest in the film when given a title of the film directly.

17. The tangible computer-readable medium of claim 16, wherein the weighted average comprises a sum of a first product of 75% and the first choice score and a second product of 25% and the definite interest score.
